(19) United States
(12) Patent Application Publication
(10) Pub. No.: US 2011/0210712 A1
(43) Pub. Date: Sep. 1, 2011

(54) AC or DC POWER SUPPLY EMPLOYING SAMPLING POWER CIRCUIT

(76) Inventor: Madhavi V. TAGARE, San Jose, CA (US)

(21) Appl. No.: 12/715,192

(22) Filed: Mar. 1, 2010

(51) Int. Cl. G05F 1/10

(52) U.S. Cl. 323/284

(57) ABSTRACT

A compact AC or DC input power supply device and method are described with an electrical power sampling circuit that includes a first switch for receiving the AC or DC voltage signal and capable of withstanding a high voltage input. A zero-crossing detector generates a zero-crossing detection ZCD signal when an input AC or DC voltage crosses or is above a zero voltage. A control circuit is coupled to the first switch for controlling the activation of the first switch from the generation of a zero-crossing detection signal. The first switch turns ON when the AC or DC input voltage is above a zero voltage, which safeguards the transfer of electrical energy to a first capacitor that is connected to the first switch. As a result, the selection of the first capacitor in the power supply device can be a low voltage capacitor.

### TECHNICAL FIELD

The present invention relates generally to integrated circuits and more particularly to electrical power supplies.

### BACKGROUND ART

Various techniques have been used for converting mains alternating current AC voltage or DC voltage into regulated direct current DC voltage through the years. Conventional solutions involve a combination of transformers and large capacitors, which imposes a limitation on the dimension on how small a power supply can be realistically designed and manufactured. These approaches are costly and consume a significant amount of space. The dimension of a power supply becomes increasingly important in an industrial design, particularly as it relates to an appliance that employs a power supply which is also relatively small.

A commercially available AC/DC power supply module is a switching power supply module with dimensions of approximately 18×21×9 mm. The current maximum deliverable output current is about 30 mA. However, this AC/DC power supply still requires a high-voltage input capacitor and a high-value output capacitor, thereby increasing the overall device size and cost. An alternative approach which attempts to reduce the size and cost of such power supplies is a topology using a Zener diode connected in series with a high-value resistor to the output of filter capacitor/rectifier bridge. This continuously burns electrical power in the resistor so that the resistor is required to have a high wattage in order to support the power loss/load current.

Accordingly, it is desirable to have an AC or DC input power supply that is more compact in size to better meet a contemporary design while reducing the costs of the integrated circuit.

### SUMMARY OF THE INVENTION

The present invention describes a compact AC or DC input power supply device and method, with an electrical power sampling circuit that includes a first switch for receiving the AC voltage signal and capable of withstanding a high voltage input. A zero-crossing detector generates a zero-crossing detection ZCD signal when an input AC voltage crosses a zero voltage. A control circuit is coupled to the first switch for controlling the activation of the first switch from the generation of a zero-crossing detection signal. The first switch turns ON when the AC input voltage crosses a zero voltage, which safeguards the transfer of electrical energy to a first capacitor that is connected to the first switch. As a result, the selection of the first capacitor in the power supply device can be a low voltage capacitor.

The control circuit has a low threshold comparator and a high threshold comparator, where the low threshold comparator compares the voltage level of a feedback signal with the voltage level of a low voltage threshold and the high threshold comparator compares the voltage level of the feedback signal with the voltage level of a high voltage threshold. When the feedback signal falls less than the low voltage threshold, the control circuit generates an asserted control signal to activate the first switch. When the feedback signal exceeds the high voltage threshold, the control circuit sends a deasserted control signal to deactivate the first switch.

The power supply device includes a second switch that is coupled between the first capacitor and a second capacitor. When the second switch is turned ON, the electrical energy from the first capacitor is transferred to the second capacitor. The voltage across the second capacitor represents an output voltage for the power supply device. A feedback network is coupled to the output voltage for producing a feedback signal to the control circuit.

In one embodiment of the invention, the first and second switches of the AC or DC input power supply are located on-chip, and the first and second capacitors are located off-chip.

In one embodiment of the invention, the first switch, the second switch, the first capacitor, and the second capacitor of the AC or DC input power supply are located off-chip.

In one embodiment of the invention, the first switch, the second switch, the first capacitor, and the second capacitor of the AC or DC input power supply are located off-chip, with an AC input that is not rectified, and a first switch is a relay switch.

In one embodiment of the invention, the first switch, the second switch, the first capacitor, and the second capacitor of the AC or DC input power supply are located off-chip, with an DC input.

In one embodiment of the invention, the input of the AC or DC input power supply is either a half-wave or a full-wave rectifier that resides off-chip.

In some embodiments of the invention, the AC or DC input power supply is used as a temperature monitor device connected to an appliance.

In some embodiments of the invention, the AC or DC input power supply is used as a compact LED driver to light emitting diode.

Broadly stated, a power supply, comprising: a threshold detector receiving an input voltage source for generating a threshold signal when the input voltage source substantially crosses a threshold voltage; a first switch for receiving the input voltage source and capable of withstanding a high voltage input; responsive to the output signal received from the threshold detector, a control circuit, coupled to the threshold detector and the first switch, for sending a control signal to activate the first switch for a predetermined period of time relative to receipt of the threshold signal; and when the first switch is activated, a first capacitor, coupled to the first switch, for storing electrical energy from the input voltage source.

Advantageously, the present invention provides an AC/DC power supply that is more compact, consumes less power, provides higher efficiency, and suitable for current industrial movement toward cleantech and more environmentally friendlier designs. The AC or DC input power supply in the present invention is designed with a lower voltage capacitor which is smaller in size coupled to the first switch, which significantly reduces the overall dimension of the power supply.

The structures and methods of the present invention are disclosed in the detailed description below. This summary does not purport to define the invention. The invention is defined by the claims. These and other embodiments, features, aspects, and advantages of the invention will become better understood with regard to the following description, appended claims and accompanying drawings.

### BRIEF DESCRIPTION OF THE DRAWINGS

The invention will be described with respect to specific embodiments thereof, and reference will be made to the drawings, in which:

FIG. 1 is a system diagram of an AC or DC input power supply with a sampling power circuit in accordance with the present invention.

FIG. 2 is a circuit diagram of a control circuit in the AC or DC power supply in accordance with the present invention.

FIG. 3 is a simplified flow chart illustrating the process flow of the AC or DC input power supply with a sampling power circuit in accordance with the present invention.

FIG. 4 is a block diagram illustrating a first embodiment of the AC or DC input power supply with the first and second switches located on-chip and the first and second capacitors located off-chip in accordance with the present invention.

FIG. 5 is a block diagram illustrating a second embodiment of the AC or DC input power supply with the first switch, the second switch, the first capacitor, and the second capacitor off-chip in accordance with the present invention.

FIG. 6 is a block diagram illustrating a third embodiment of the AC or DC input power supply with the first switch, the second switch, the first capacitor, and the second capacitor located off-chip, where the input AC is not rectified, and a first switch is a relay switch in accordance with the present invention.

FIG. 7 is a block diagram illustrating a fourth embodiment of the AC or DC input power supply with the first switch, the second switch, the first capacitor, and the second capacitor located off-chip, and a DC input in accordance with the present invention.

FIG. 8 is a block diagram illustrating a fifth embodiment of the AC or DC input power supply with a half-wave or a full-wave rectifier which resides off-chip in accordance with the present invention.

FIG. 9 is a block diagram illustrating a first exemplary application of the AC or DC input power supply for use as a temperature monitor device in accordance with the present invention.

FIG. 10 is a block diagram illustrating a second exemplary application of the AC or DC input power supply for use as a compact LED driver in accordance with the present invention.

FIG. 11A is a circuit diagram of a full-wave rectifier in accordance with the present invention; FIG. 11B is a circuit diagram of a half-wave rectifier in accordance with the present invention.

FIG. 12 is a timing diagram illustrating various waveforms of the operational processes in the control circuit in accordance with the present invention.

FIG. 13 is a waveform illustrating a voltage waveform in steady state with a full-wave rectified AC input in accordance with the present invention.

FIG. 14 is a waveform illustrating a voltage waveform in steady state with a half-wave rectified AC input in accordance with the present invention.

FIG. 15 is a waveform illustrating a voltage waveform in steady state with a DC input in accordance with the present invention.

FIG. 16 is a waveform illustrating multiple pulses with rising and falling portions of the AC input in accordance with the present invention.

### DETAILED DESCRIPTION

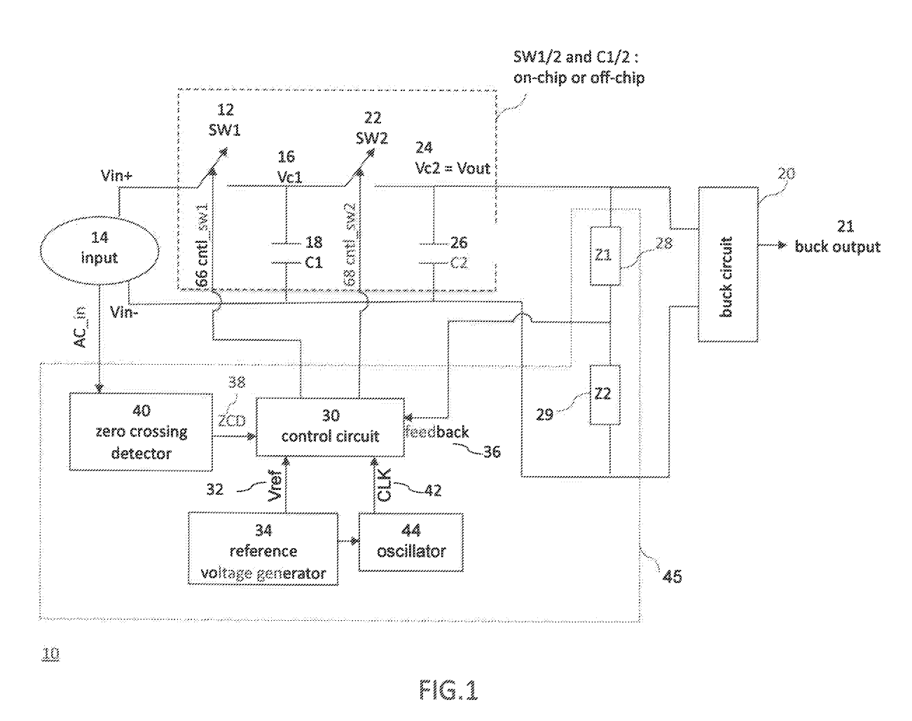

A description of structural embodiments and methods of the present invention is provided with reference to FIGS. 1-16. It is to be understood that there is no intention to limit the invention to the specifically disclosed embodiments but that the invention may be practiced using other features, elements, methods and embodiments. Like elements in various embodiments are commonly referred to with like reference numerals.

FIG. 1 is an architectural diagram of a sampling power system 10 employing AC or DC (alternating current/direct current) input power supply circuit. The architecture of the sampling power system 10 produces a regulated DC voltage from an input source, which can be either an AC voltage or a DC voltage. In this embodiment, the operations of the sampling power system 10 can be viewed as occurring in five stages. At a first stage, a first switch (SW1) 12 samples an input energy source 14. The input energy source 14 can be generated from various electric charges, such as a DC signal, an AC signal, or a rectified AC signal. At a second stage, a first sampling capacitor (C1) 18 stores an electrical energy, denoted as Vc1 16, before delivering the electrical energy to the second capacitor C2 26. Next, at a third stage, a second switch (SW2) 22 transfers the electrical energy Vc1 16 from the first storage capacitor C1 18 to a second (or output) capacitor (C2) 26. At a fourth stage, the output capacitor C2 26 stores the electrical energy, as denoted by the symbol, Vc2 24, while maintaining an output voltage, which is equal to the voltage of Vc2 24. The output capacitor C2 26 supplies electrical energy to the load 20. In this instance, the load 20 is implemented as a buck circuit 20 with a buck output 21, which can reside either on-chip or off-chip. At a fifth stage, a control circuit 30 receives several inputs, including a reference voltage (Vref) 32 generated from a reference voltage generator 34, a feedback voltage 36 from a feedback network comprising of a first impedance 28 and a second impedance 29, and a zero crossing detect (ZCD) signal 38 for an input AC generated from a zero crossing detector 40, as well as a clock signal (CLK) 42 from the oscillator 44. The control circuit 30 controls the timing and duration for switching the first switch SW1 12 and the second switch SW2 22. The internal oscillator 44 is used to generate the timing and control pulses for the first and second switches, SW1 12 and SW2 22. A buck regulator 20 is connected to the output of the capacitor C2 26 in order to maintain a high accuracy voltage. The buck circuit 20 generates a buck output 21. The buck regulator 20 functions as load, which can be part of the power supply 10 or separate from the power supply 10.

To perform a conversion from an AC voltage to a DC voltage, the input energy source 14 can be generated from various types of signals, such as a rectified AC signal. The zero crossing detector 40 generates a zero crossing detect signal ZCD 38, which triggers the first switch SW1 12 to sample the input 14. The first switch SW1 12 is turned ON only during a low voltage portion of the input 14. The first SW1 12 remains in an OFF state during a high voltage portion of the input 14. Because the first capacitor C1 does not observe a high voltage due to the operations of the first switch SW1 12, the first capacitor C1 18 can be selected with a low voltage capacitor (rather than a high voltage capacitor in a conventional power supply). The low voltage feature of the first capacitor C1 18 provides several distinct advantages, including enabling the design with a small form factor, or implemented as a ceramic capacitor. In one embodiment, the first capacitor C1 18 has a capacitive value ranging from about 4.7 to about 50 microfarads (μf), 25 volts.

After the first switch SW1 12 is turned OFF, the second switch SW2 22 is turned ON at a later point in time. However, the first switch SW1 12 and the second switch SW2 22 cannot be turned ON at the same time. When the second switch SW2 22 is turned ON, an electrical connection is established between the first capacitor C1 18 and the second capacitor C2 26 so that the electrical energy stored in the first capacitor C1 18 is transferred to the second capacitor C2 26.

Upon storage of electrical energy in the second capacitor C2 26, the voltage level at node 24 is represented by the voltage Vc2 24 (also referring to as an output voltage, Vout). The output voltage Vout 24 is sensed through a feedback network (Z1 28 and Z2 29), which can also be characterized as impedance or a voltage divider. The feedback signal 36, which feeds into the control circuit 30, is produced from the output voltage Vout 24, propagating through the impedances Z1 28 and Z2 29. The control circuit 30 compares the feedback signal 36 with a reference voltage, Vref 32, that is generated by the reference voltage generator 34.

When the voltage level of the feedback signal 36 equals to the voltage level of the reference voltage 32, which indicates that the target voltage level of Vout has been reached, both the first switch SW1 12 and the second switch SW2 22 are turned OFF. Subsequently, when the voltage level of the feedback signal 36 becomes less than the voltage level of the reference voltage Vref 32, which indicates that Vout has dropped below a voltage threshold, the first switch SW1 12 and the second switch SW2 22 turn ON to charge up again the output voltage Vout 24.

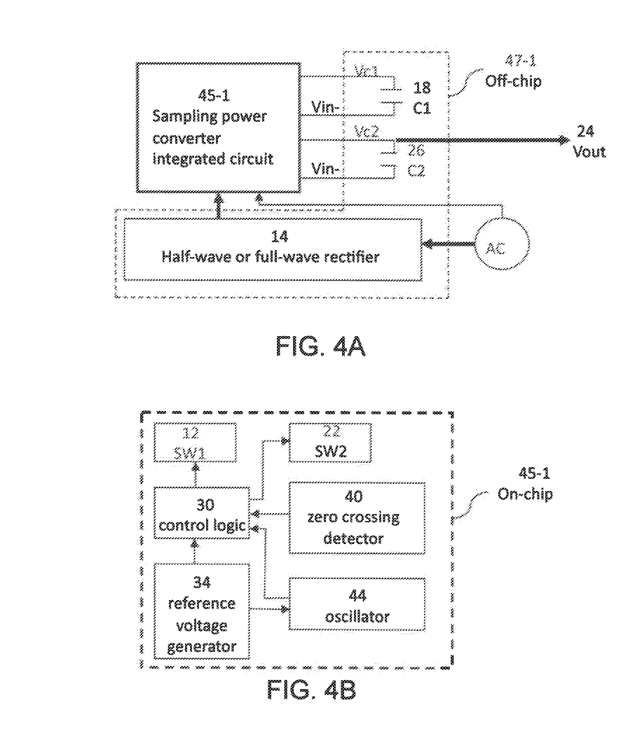

Various components in the sampling power system 10 can reside either on-chip or off-chip. For example, some combinations of the first switch SW1 12, the second switch SW2 22, the first capacitor C1 18, and the second capacitor C2 26, can be placed either as on-chip or off-chip, which is further illustrated in FIGS. 4-8. In one embodiment, the components that are within a dotted box 45 are integrated on-chip, including the control circuit 30, the zero crossing detector 40, the reference voltage generator 34, the oscillator 44, the first and second impedances 28, 29.

The overall performance and efficiency of the sampling power system 10 are dependent on a variety of the following factors. The time at which the first switch SW1 12 turns ON to sample the input (for instances when the input is an AC signal). The duration for in which the first switch SW1 12 is ON. The first two factors combine to affect a voltage level to which the first capacitor C1 18 charges. Another factor is the time duration to which the second switch SW2 22 is turned ON. The resistance values in the first switch SW1 12 and the second switch SW2 22 also affect the overall system performance. Other additional factors are the target output voltage Vout, the allowed variation of the output voltage Vout, and the maximum load current.

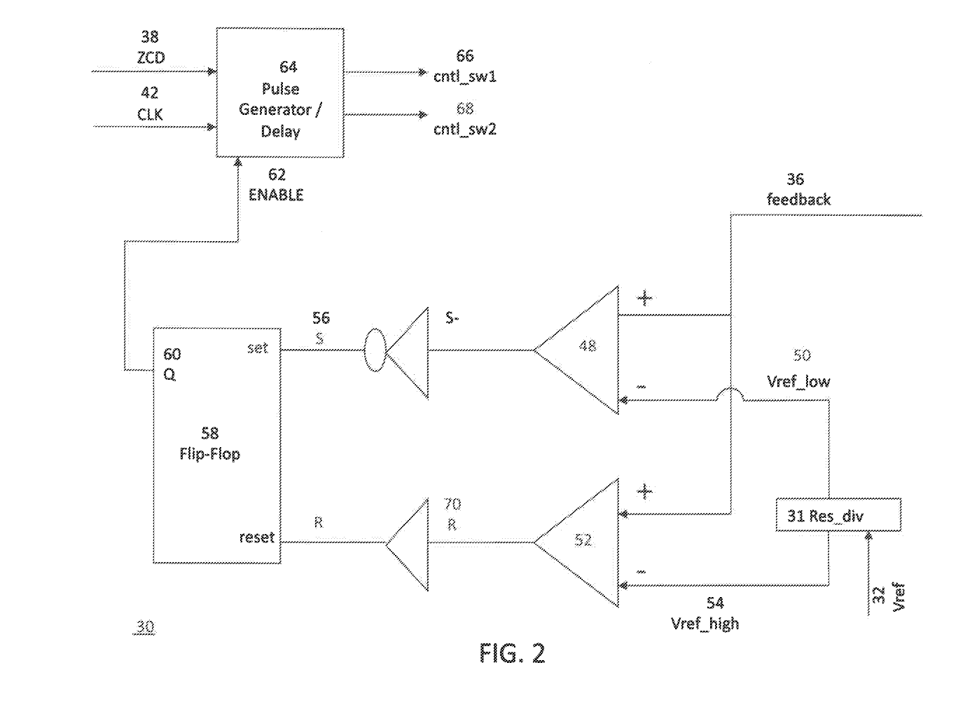

FIG. 2 is a block diagram illustrating the circuits resident in the control circuit 30. The control circuit 30 receives several input signals, including the ZCD signal 38 from the zero-cross detector 40, the CLK 42 signal from the oscillator 44, the feedback signal 36 from the feedback network 28, 29 (or voltage divider), and the Vref signal 32 from the reference voltage generator 34. A Res_div block 31 receives the signal Vref 32 and generates two different threshold voltages. In one embodiment, the Res_div block 31 comprises a resistance ladder that produces two output voltages, a low voltage reference signal Vref_low 50 and a high voltage reference signal Vref_high 54. In this embodiment, the control circuit 30 includes a low threshold comparator 48 and a high threshold comparator 52 for comparing the feedback signal 36 to determine if the feedback signal falls below a low voltage level or exceeds a high voltage level. The low threshold comparator (comp_low) 48 receives a first input of the feedback signal 36 and a second input of the low voltage reference signal (Vref_low) 50. The high threshold comparator 52 receives a first input of the feedback signal 36 and a second input of the high voltage reference signal (Vref_high) 54. When the voltage level of the feedback signal 36 falls below the lower threshold voltage Vref_low 50, the low threshold comparator 48 enters into a low state, and sets an input S 56 to a flip-flop 58 to a high state. This in turn causes an output signal, Q 60, of the flip-flop 58 to get asserted and asserts an ENABLE signal 62 to a pulse generator 64. When the Vout 24 charge increases, and the voltage level of the feedback signal 36 reaches a voltage level that is above the higher threshold (Vref_high) 54, the high threshold comparator 52 asserts a high output R 70. The high output R 70 causes the flip-flop 58 to reset, and the flip-flop 58 sends the Q signal 60 that is deasserted to the pulse generator 64, via the deasserted ENABLE signal 62. The timing of CNTL_SW1 66 and CNTL_SW2 68 are regulated by the ZCD signal 38, the clock CLK 42 and internal design delays in the pulse generator 64 and enabled by ENABLE signal 62. In response to the asserted ENABLE signal 62, the ZCD signal 38 and the clock CLK 42, the pulse generator 64 in turn sends the CNTL_SW1 signal 66 to the first switch SW1 12 for a first predetermined time period and the CNTL_SW2 signal 68 to the second switch SW2 22 for a second predetermined time period. The deasserted ENABLE signal 62 inhibits the enabling of the first switch SW1 12 through the CNTL_SW1 signal 66 and inhibits the enabling of second switch SW2 22 through the CNTL_SW2 signal 68.

When the electrical appliance (i.e., the load 20) is in a standby mode, which draws an insignificant amount of electrical current, the switching is automatically minimized because of the way the control circuit 30 is designed. More specifically, because the second capacitor C2 26 does not discharge a significant amount of charge under this condition, the control circuit 30 does not turn ON the first switch SW1 12 and the second switch SW2 22.

When the variation of the output voltage Vout is relatively large (e.g., 50%), this will in turn lower the duration of the switching of the first switch SW1 12 and the second switch SW2 22. The idling time of the sampling power system 10 also increases as a result of the large variation in the output voltage, Vout 24. The buck regulator 20 is connected to the output voltage, Vout 24, to provide a higher accuracy output, while at the same time keeping overall efficiency high since bucks can typically achieve greater than 90% efficiency.

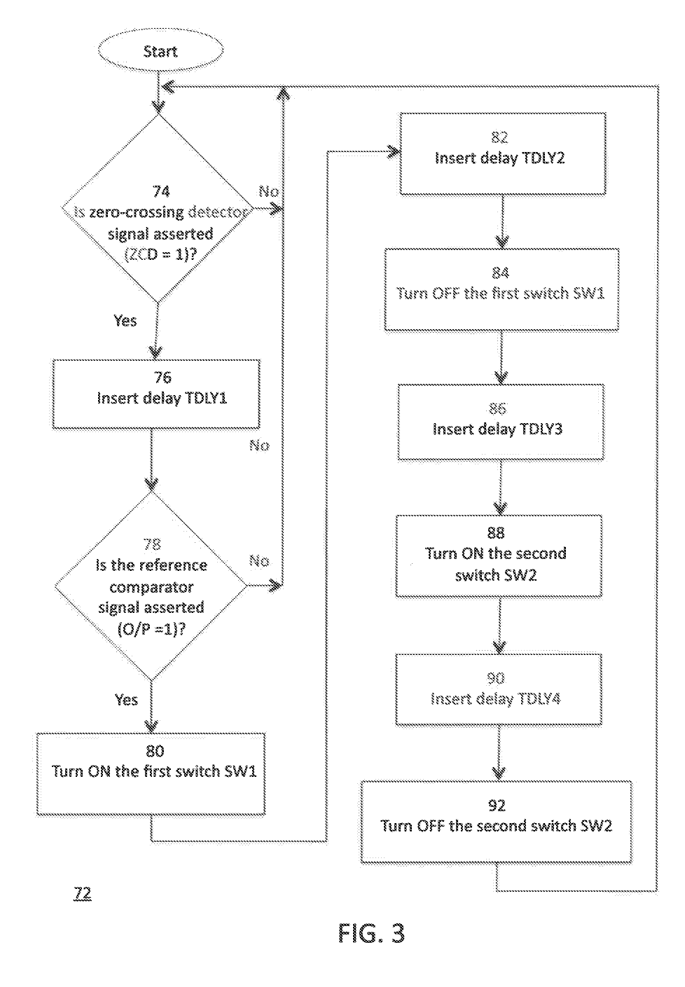

FIG. 3 is a simplified flow chart illustrating a process flow 72 of the control circuit 30 in the sampling power supply. At step 74, the pulse generator 64 in the control circuit 30 detects whether the zero crossing detect signal is asserted. If the zero crossing detect signal remains unasserted, the process continues to wait for the assertion of the zero crossing detect signal. Once the zero crossing detect signal is asserted, the pulse generator 64 inserts a time delay TDLY1 at step 76 before checking the output of the low threshold comparator 48. At step 78, when the feedback signal 36 is less than the voltage level of Vref_low 50, the low threshold comparator 48 generates the S signal 56 which sets the flip-flop 58, which in turn asserts the ENABLE (or reference comparator) signal 62. If the ENABLE signal 62 remains unasserted, the process 72 continues to wait for the assertion of the next zero crossing detect signal by returning to step 74. If the ENABLE signal 62 is asserted, then pulse generator 64 generates a CNTL_SW1 66 signal to the first switch SW1, which turns ON the first switch SW1 at step 80, and starts a counter for delay TDLY2. After the passing of a predetermined time of delay in TDLY2 in step 82, the pulse generator 64 generates a deasserted CNTL_SW1 to turn OFF the first switch SW1 at step 84. At step 86, after the passing of a predetermined time of delay in TDLY3 ensuring that the switching between the first SW1 and the SW2 22 does not overlap, the pulse generator 64 generates an asserted CNTL_SW2 signal 68 to turn ON the second switch 22 at step 88. At step 90, the control circuit 30 injects a delay TDLY4 of a predetermined period of time. At step 92, the purse generator 64 turns OFF the second switch SW 22, at which time the process 72 returns to step 74.

In one embodiment, the control circuit 30 may control the power supply depending on the electrical current drawn by the load 20. An over-current sensor may provide additional feedback to the control circuit 30 to halt the switching functions in the first switch SW1 12 and the second switch SW2 22, and isolate the output side from the input side, which protects the first switch SW1 12 and the second switch SW2 22 from any damage caused by excess electrical current, as well as avoiding any hazards to an electrical appliance (now shown) due to a sudden short circuit occurrence.

FIGS. 4A-4B are block diagrams illustrating a first embodiment of the AC or DC input power supply with the first and second switches located on-chip and the first and second capacitors located off-chip 47-1. In FIG. 4A, the sampling power converter integrated circuit 45-1 is designed to be on-chip, which is further expanded in FIG. 4B that includes the first switch SW1 12 and the second switch SW2 22. The first capacitor C1 18 and the second capacitor C2 26 are located off-chip, as shown by the dotted line 47-1 in FIG. 4A. The input energy source 14 feeding into the sampling power converter integrated circuit 45-1 can be generated from a half-wave rectifier or a full-wave rectifier.

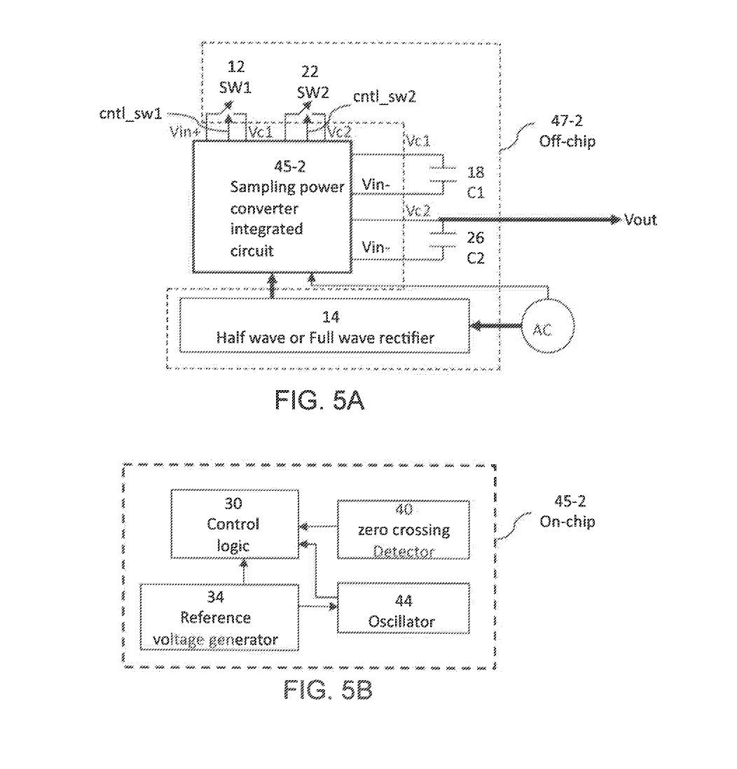

FIGS. 5A-5B are block diagrams illustrating a second embodiment of the AC or DC input power supply with the first switch, the second switch, the first capacitor, and the second capacitor off-chip. In FIG. 5A, the sampling power converter integrated circuit 45-2 is designed to be on-chip, while the first switch SW1 12, the second switch SW2 22, the first capacitor C1 18, and the second capacitor C2 26 are placed off-chip 47-2. In FIG. 5B, the sampling power converter integrated circuit 45-2, which is located on-chip, includes the control circuit 30 coupled to the reference voltage generator 34, the zero-crossing detector 40, and the oscillator 44. The input energy source 14 feeding into the sampling power converter integrated circuit 45-2 can be generated from a half-wave rectifier or a full-wave rectifier.

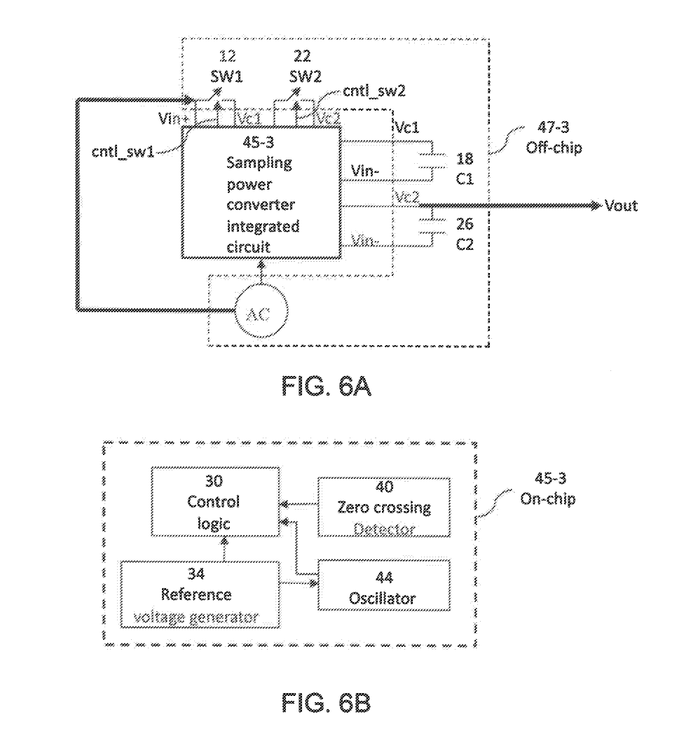

FIGS. 6A-6B are block diagrams illustrating a third embodiment of the AC or DC input power supply with the first switch, the second switch, the first capacitor, and the second capacitor off-chip, the input AC not rectified, and a first switch is a relay switch. In FIG. 6A, the sampling power converter integrated circuit 45-3 is designed to be on-chip, while the first switch SW1 12, the second switch SW2 22, the first capacitor C1 18, and the second capacitor C2 26 are placed off-chip 47-3. In FIG. 6B, the sampling power converter integrated circuit 45-3, which is located on-chip, includes the control circuit 30 coupled to the reference voltage generator 34, the zero-crossing detector 40, and the oscillator 44. The input energy source 14 feeding into the sampling power converter integrated circuit 45-3 is generated from an AC signal, instead of a rectified signal.

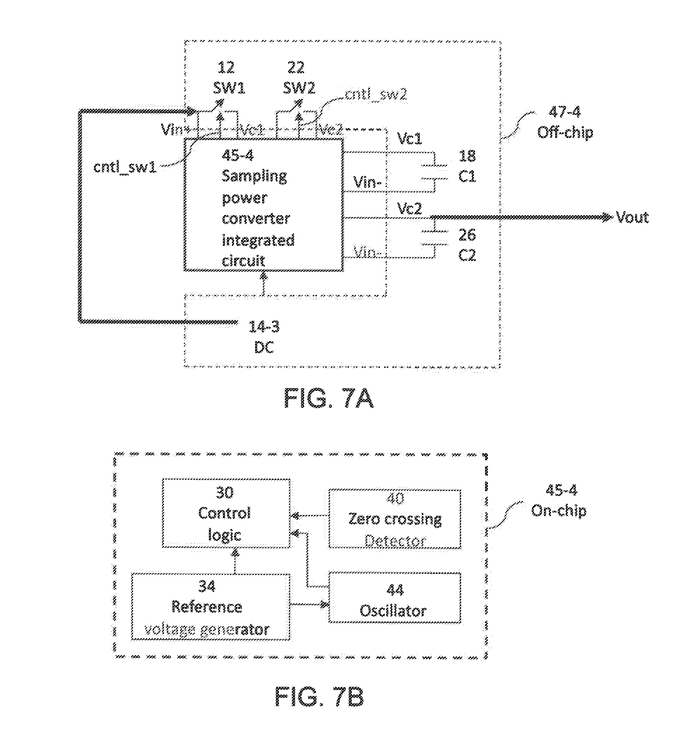

FIGS. 7A-7B are block diagrams illustrating a fourth embodiment of the AC or DC input power supply with the first switch, the second switch, the first capacitor, and the second capacitor off-chip, with a DC input 14-3, such that the AC or DC input power supply functions as a DC/Dc power supply. In FIG. 7A, the sampling power converter integrated circuit 45-4 is designed to be on-chip, while the first switch SW1 12, the second switch SW2 22, the first capacitor C1 18, and the second capacitor C2 26 are placed off-chip 47-4. In FIG. 7B, the sampling power converter integrated circuit 45-4, which is located on-chip, includes the control circuit 30 that is coupled to the reference voltage generator 34, the zero-cross detector 40, and the oscillator 44. The input energy source 14 feeding into the sampling power converter integrated circuit 45-3 is generated from the DC signal 14-3, instead of an AC signal or a rectified signal. In this embodiment with the DC signal 14-3, the zero crossing detector 40 is kept in an enabled state all the time.

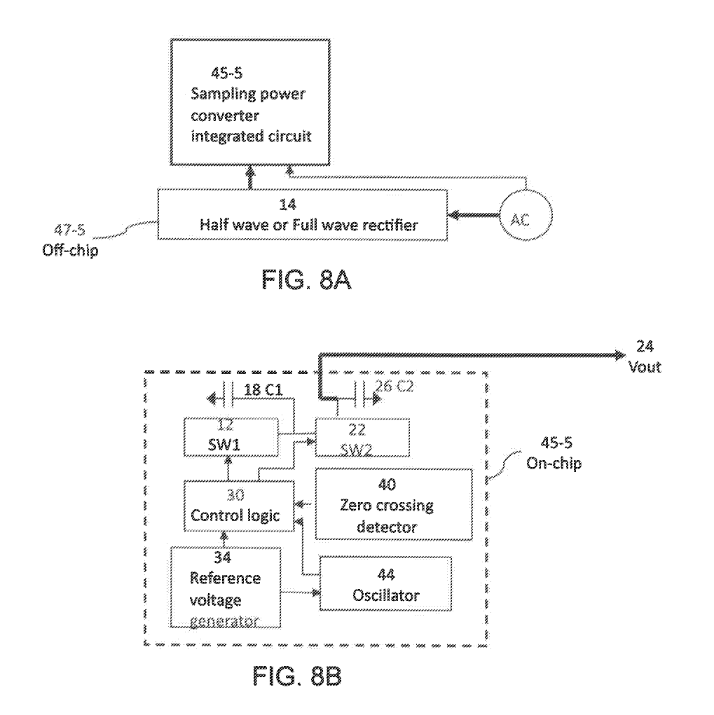

FIG. 8A-8B are block diagrams illustrating a fifth embodiment of the AC or DC input power supply with a half-wave or full-wave rectifier which resides off-chip. In FIG. 8A, the sampling power converter integrated circuit 45-5 is designed to be on-chip that includes the first switch SW1 12, the second switch SW2 22, the first capacitor 18, and the second capacitor 26. The input energy source 14 feeding into the sampling power converter integrated circuit 45-5 can be generated from a half-wave rectifier or a full-wave rectifier, which resides in off-chip 47-5 in this embodiment. In FIG. 8B, the control circuit 30 coupled to inputs from the reference voltage generator 34, the zero-cross detector 40, and the oscillator 44. The control circuit 30 has outputs coupled to the first switch SW1 12 and the second switch SW2 22. The first capacitor C1 18 is coupled between the first switch SW1 12 and the second switch SW2 22. The second switch SW2 22 is further coupled to the second capacitor C2 26, which is coupled to the output voltage Vout 24.

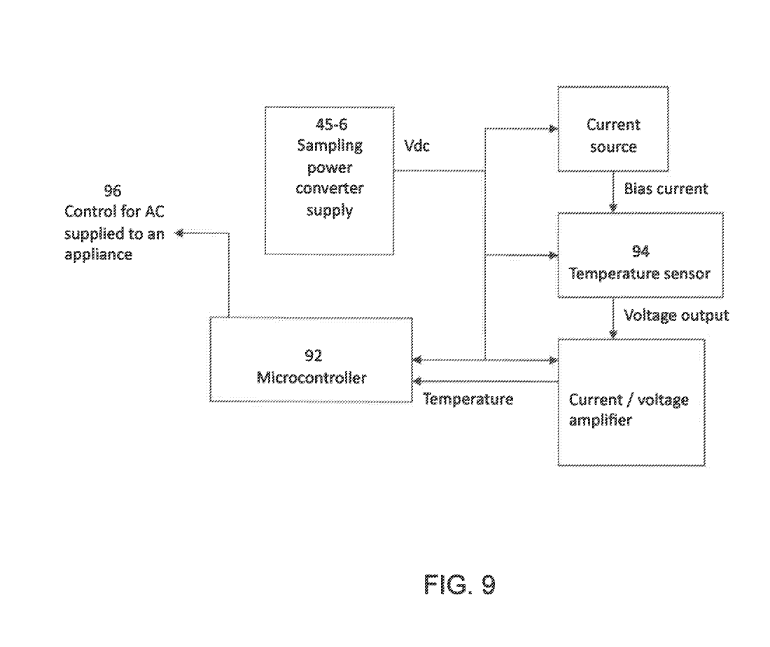

FIG. 9 is a block diagram illustrating a first exemplary application of the sampling AC or DC input power converter supply 45-6 for use as a temperature monitoring device. The sampling power converter supply 45-6 provides a compact temperature monitor device that can serve as a type of circuit breaker for an appliance, such as a laundry washer, a refrigerator, and others. One of skill in the art should recognize that there are many other applications in which the sampling power converter supply 45-6 can be used for, such as computer networks, computer servers or cell phone battery chargers.

The source of power for the sampling power converter supply 45-6 can be supplied by mains AC electrical energy, which alleviates the need to change batteries in an appliance. A microcontroller 92 could be added to create various algorithms dependent on temperature data received from a temperature sensor 94. When the temperature sensor 94 exceeds a preset temperature, the microcontroller 92 generates a control signal 96 to interrupt the power to the appliance. In a similar fashion, environmental parameters, such as ambient lighting or motion, may be sensed and fed to the microcontroller 92 for controlling operations of the appliance.

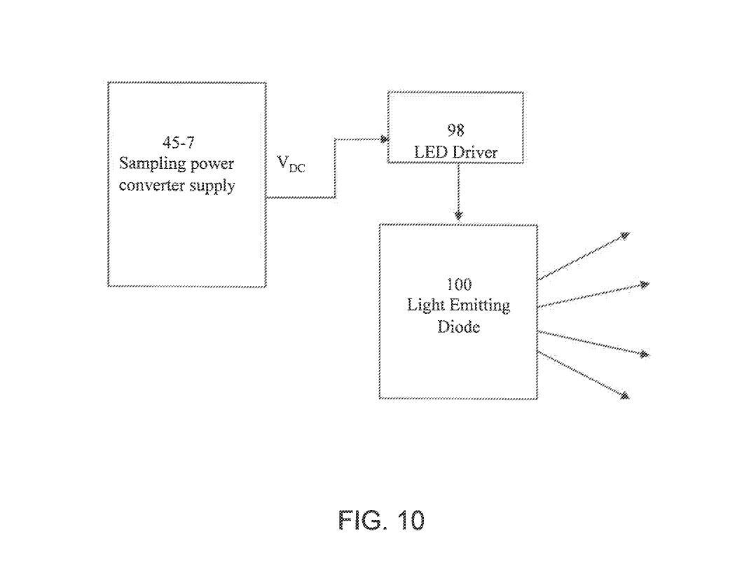

FIG. 10 is a block diagram illustrating a second exemplary application of the AC or DC input sampling power converter supply 45-7 for use as a compact LED driver. The sampling power converter supply is capable of generating DC voltage and current sufficient to drive an LED driver 98, which in turn supply the power to light emitting diode 100. This design advantageously makes the overall solution space and cost efficient.

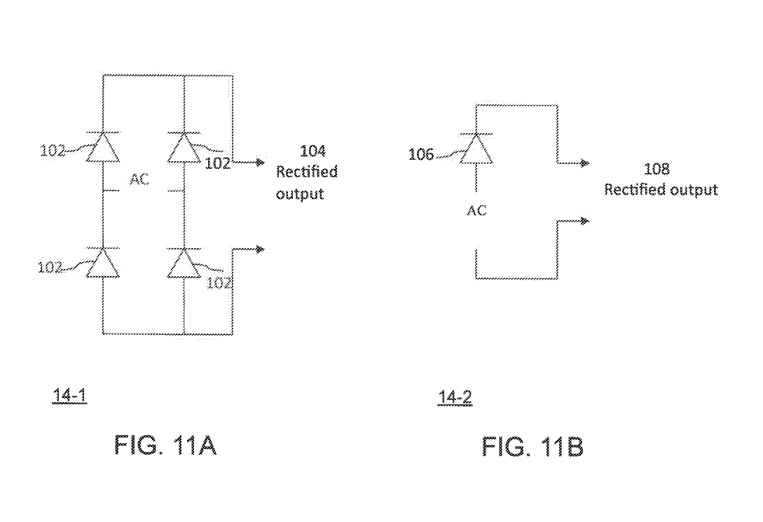

FIGS. 11A-11B are circuit diagrams illustrating a full-wave rectifier and a half-wave rectifier, respectively. A full-wave rectifier 14-1 in FIG. 11A is constructed with four diodes 102 that convert both positive and negative polarities of an input waveform to direct current DC. The full-wave rectifier 14-1 coverts alternating current AC to direct current DC, and generates a rectified output 104. Rectifiers are commonly used as components of power supplies. A half-wave rectifier 14-2 in FIG. 11B is implemented with a single diode 106 to rectify alternating current AC by blocking the negative or positive section of alternating current AC waveform, and passing either the positive half or negative half of the AC waveform to a rectified output 108.

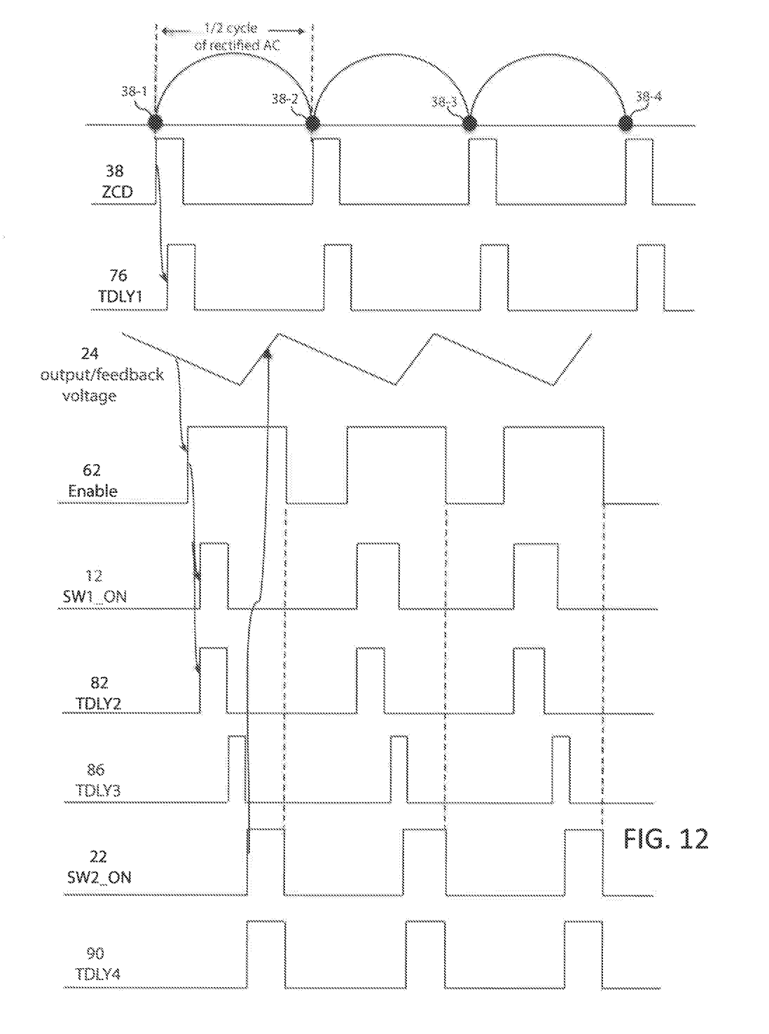

FIG. 12 is timing diagram illustrating various waveforms of the operational processes in the control circuit 30. The zero-crossing detector 40 generates a zero-crossing detection ZCD signal 38 of a predetermined pulse width, when an input AC voltage crosses a zero voltage 38-1, 38-2, 38-3 and 38-4. The zero crossing detection ZCD signal 38 triggers the assertion of the TDLY1 76, in which the first time delay TDLY1 76 remains asserted for a predetermined period of time, t1. When the voltage value of the feedback voltage 36 is less than the voltage value of the low voltage threshold Vref_low 50, the low threshold comparator 48 causes the flip-flop 58 to assert the ENABLE signal 62. After the TDLY1 signal 76 has been deasserted, the first switch SW1 12 is turned ON if the ENABLE signal 62 is asserted. The first switch SW1 12 remains in ON state for a predetermined period of time, t2, as set forth in the duration for the second time delay TDLY2 82. After the first switch SW1 12 is turned OFF, the time delay TDLY3 86 is asserted for a predetermined period of time, t3. The second switch SW2 22 is turned ON when the third time delay TDLY3 86 is deasserted. The third time delay TDLY3 signal 86 is used to ensure that the first switch SW1 12 and the second switch SW2 22 are non-overlapping. When the second switch SW2 22 is turned ON, the feedback voltage 36 begins to rise. When the voltage value of the feedback voltage 36 exceeds the voltage value of the high voltage threshold Vref_high 54, the high threshold comparator 52 causes the flip-flop 58 to deassert the ENABLE signal 62. The second switch SW2 22 remains in ON state for a predetermined period of time, t4, as set forth in the fourth time delay TDLY4 90, unless the ENABLE signal 62 is deasserted before the TDLY4 signal 90 is deasserted. In such instance, the ENABLE signal 62 overwrites the fourth time delay TDLY4 signal 90 such that the second switch SW2 is turned OFF when the ENABLE signal 62 is deasserted, even though the fourth time delay TDLY4 signal 90 has not been deasserted yet. All the delays, the first time delay TDLY1 76, the second time delay TDLY2 82, the third time delay TDLY3 86, and the fourth time delay TDLY4 90 in this embodiment are regulated by the timing of the clock CLK 42.

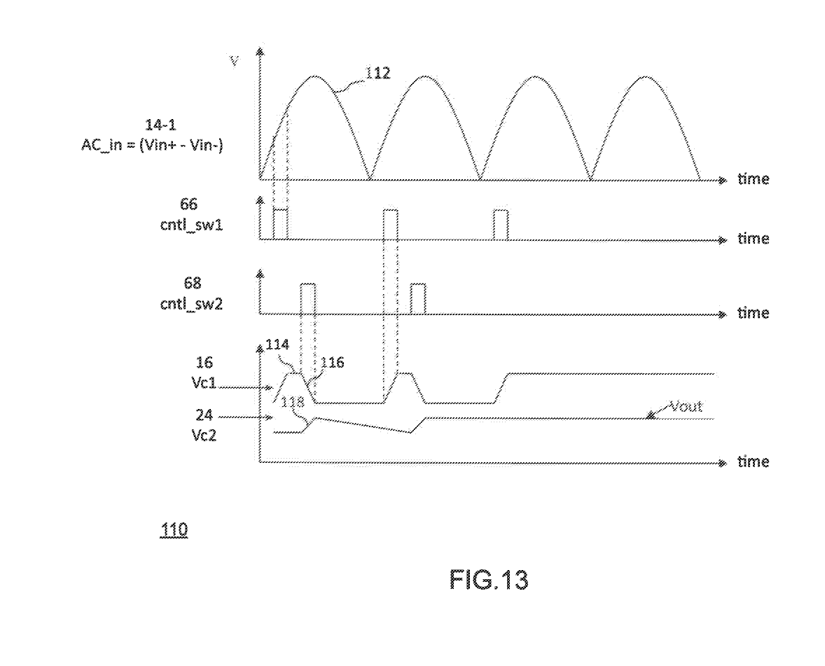

FIG. 13 is a timing diagram 110 illustrating a voltage waveform in steady state with a full-wave rectified AC input 14-1. The Input 14, which in this instance is also referred to as the full-wave rectified AC input 14-1, is a full-wave rectified AC, which provides both positive and negative cycles of the alternating current AC as shown in a waveform 112. The control circuit 30 turns ON the first switch SW1 12 just after the alternating current AC has crossed a zero voltage, which is indicated by the ZCD signal 38 generated from the zero-cross detector 40. The duration of ON time in the first switch SW1 12 is calculated so that the voltage seen by the first capacitor C1 18 when the first switch SW1 12 is ON state is less than a specified voltage value, e.g. 25V. This design advantageously eliminates the need to have a high voltage (e.g. greater than 150V) capacitor. During this period, the voltage across the first capacitor C1 18 ramps up as shown in a waveform 114. After the first switch SW1 12 is turned OFF, the control circuit 30 turns ON the second switch SW2 22, which causes the transfer of electrical charge from the first capacitor C1 18 to the second capacitor C2 26, thereby ramping up the voltage across the second capacitor C2 26 as shown in waveform 116, and ramping down the voltage across the first capacitor C1 18 as shown in waveform 118. This process typically repeats every cycle and maintaining the Vout 24 within the high and low limits set for the low threshold comparator 48 and high threshold comparator 52, and compare against the feedback voltage 36 affected by the impedances Z1 28, Z2 29.

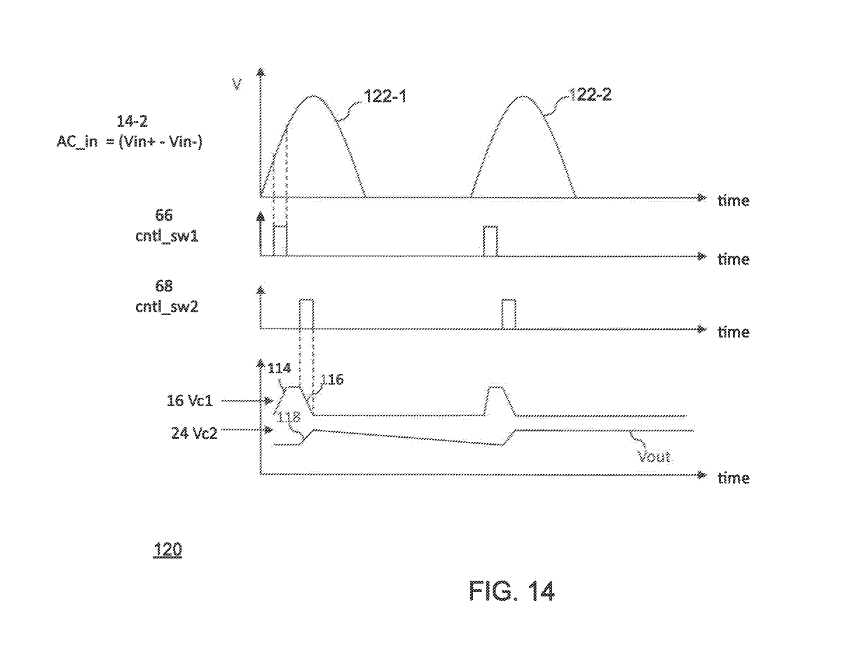

FIG. 14 is a timing diagram 120 illustrating a voltage waveform in steady state with a half-wave rectified AC input. The timing diagram 120 shows the operation for a half wave rectified AC input 14-2 where alternate input cycles 122-1 and 122-2 are passed through. During this period, the voltage across the first capacitor C1 18 ramps up as shown in a waveform 114. After the first switch SW1 12 is turned OFF, the control circuit 30 turns ON the second switch SW2 22, which causes the transfer of electrical charge from the first capacitor C1 18 to the second capacitor C2 26, thereby ramping up the voltage across the second capacitor C2 26 as shown in waveform 116, and ramping down the voltage across the first capacitor C1 18 as shown in waveform 118. This process typically repeats every cycle and maintaining the Vout 24 within the high and low limits set for the comparators 48, 52, and compared against the feedback voltage 36 affected by the impedances Z1 28, Z2 29.

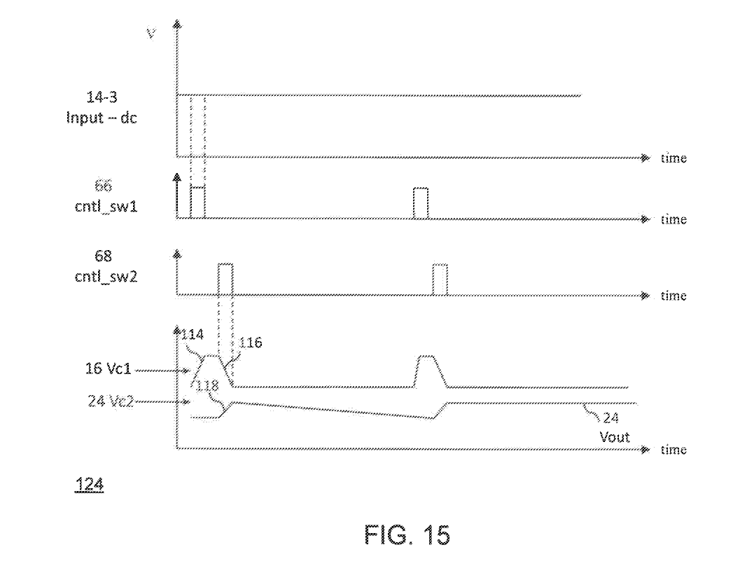

FIG. 15 is a timing diagram 124 illustrating a voltage waveform in steady state with a DC input 14-3. With the DC input 14-3, it is not necessary to have a zero-cross-detect ZCD signal. During this period, the voltage across the first capacitor C1 18 ramps up as shown in a waveform 114. After the first switch SW1 12 is turned OFF, the control circuit 30 turns ON the second switch SW2 22, which causes the transfer of electrical charge from the first capacitor C1 18 to the second capacitor C2 26, thereby ramping up the voltage across the second capacitor C2 26 as shown in waveform 116, and ramping down the voltage across the first capacitor C1 18 as shown in waveform 118. This process typically repeats at a predetermined period or cycle while maintaining the Vout 24 within the high and low limits set for the comparators 48, 52, and compared against the feedback voltage 36 affected by the impedances Z1 28, Z2 29.

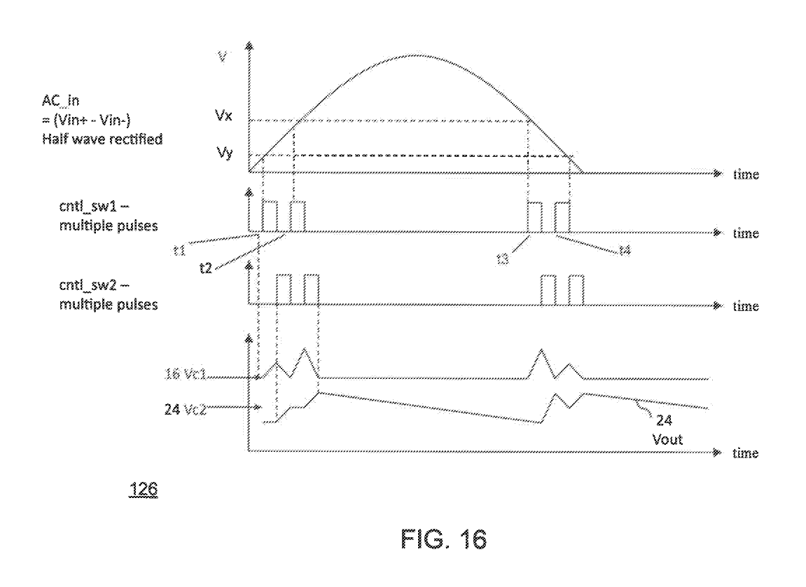

FIG. 16 is a timing diagram 126 illustrating multiple pulses with rising and falling portions of the AC. The control circuit can switch the first switch SW1 12 and the second switch SW2 22 on the rising portion of an AC cycle, and can also switch the first switch SW1 12 and the second switch SW2 22 on the falling portion of the AC cycle. The control circuit 30 calculates the time from the zero crossing point to make sure the voltage has dropped below the peak specified for first capacitor C1 18. Rather than switching the first switch SW1 12 and the second switch SW2 22 only once per AC cycle, the control circuit 30 is able to generate multiple pulses to transfer energy from the input 14 to the first capacitor C1 18, and from the first capacitor C1 18 to the second capacitor C2 26. This alternative embodiment makes it possible to transfer more energy, and hence support a larger load at the output.

Table 1 provides a sample comparison of various AC to DC converter topologies with exemplary specifications for current implementations.

TABLE 1

| AC to DC converter | Size | Cost | Efficiency |
|---|---|---|---|
| Switching power supply | 18 × 21 mm | $$$$$ | 33% |
| Bridge + Zener | 4 × 8 mm | $ | 2% |
| Sampling power supply | 3 × 6 mm | $$ | >50% |

Unless specifically stated otherwise as apparent from the above discussion, it is appreciated that throughout the description, discussions utilizing terms such as “detecting” or “determining” or “comparing” or the like, refer to the action and processes of a computer system, or similar electronic computing device, that manipulates and transforms data represented as physical (electronic) quantities within the computer system memories or registers or other such information storage, transmission or display devices.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” or “communicatively coupled” as used herein are defined as connected, although not necessarily directly, and not necessarily mechanically.

The invention can be implemented in numerous ways, including as a process, an apparatus, a system, a computer readable medium such as a computer readable storage medium. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The present invention has been described in particular detail with respect to one possible embodiment. Those of skilled in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

An ordinary artisan should require no additional explanation in developing the methods and systems described herein but may nevertheless find some possibly helpful guidance in the preparation of these methods and systems by examining standard reference works in the relevant art.

These and other changes can be made to the invention in light of the above detailed description. In general, in the following claims, the terms used should not be construed to limit the invention to the specific embodiments disclosed in the specification and the claims, but should be construed to include all methods and systems that operate under the claims set forth herein below. Accordingly, the invention is not limited by the disclosure, but instead its scope is to be determined entirely by the following claims.

I claim:

1. A power supply, comprising:
a threshold detector receiving an input voltage source for generating a threshold signal when the input voltage source substantially crosses a threshold voltage;
a first switch for receiving the input voltage source and capable of withstanding a high voltage input;
responsive to the output signal received from the threshold detector, a control circuit, coupled to the threshold detector and the first switch, for sending a control signal to activate the first switch for a predetermined period of time relative to receipt of the threshold signal; and
when the first switch is activated, a first capacitor, coupled to the first switch, for storing electrical energy from the input voltage source.

2. The power supply of claim 1, wherein the threshold detector comprises a zero crossing detector.

3. The power supply of claim 2, wherein the input voltage source comprises an AC voltage.

4. The power supply of claim 1, wherein the threshold voltage comprises a zero voltage.

5. The power supply of claim 1, wherein the input voltage source comprises a DC voltage.

6. The power supply of claim 1, further comprising:
a second capacitor; and
a second switch, coupled between the first capacitor and the second capacitor, for transferring electrical energy from the first capacitor to the second capacitor when the second switch is activated.

7. The power supply of claim 6, wherein a voltage on the second capacitor represents an output voltage for the power supply.

8. The power supply of claim 7, further comprising a feedback network, coupled to the output voltage, for generating a feedback signal to the control circuit.

9. The power supply of claim 8, wherein the feedback network comprises a first impedance connected in series with a second impedance.

10. The power supply of claim 1, further comprising a reference voltage generator, coupled to the control circuit, for generating a high reference voltage and a low reference voltage.

11. The power supply of claim 8, wherein the control circuit comprises:
a low threshold comparator, the low threshold comparator having a first input for receiving the feedback signal, a second input for receiving a low threshold voltage level, the low threshold comparator comparing the feedback signal and the low threshold voltage level to generate a first comparator output signal; and
a high threshold comparator, the high threshold comparator having a first input for receiving the feedback signal, a second input for receiving a high threshold voltage level, the high threshold comparator comparing the feedback signal and the high threshold voltage level to generate a second comparator output signal.

12. The power supply of claim 3, wherein the predetermined period of time comprises a full cycle.

13. The power supply of claim 3, wherein the predetermined period of time comprises a fraction of cycle.

14. The power supply of claim 6, wherein at least the control circuit is integrated on an integrated circuit chip.

15. A method for power conversion, comprising:
detecting by a threshold voltage detector when an input voltage source crosses a threshold voltage, thereby generating a threshold detect signal;
activating a first switch, by a control circuit, in response to receiving the threshold detect signal, the first switch being capable of withstanding a high voltage input; and
transferring electrical energy from the input voltage source to a first capacitor coupled to the first switch.

16. The method of claim 15, further comprising:
after a predetermined period of time, deactivating the first switch and activating a second switch, the second switch being coupled between the first capacitor and a second capacitor, the second switch being activated for transferring electrical energy from the first capacitor to the second capacitor, the second capacitor having a voltage that represents an output voltage for the power supply.

17. The method of claim 16, further comprising comparing by a low threshold comparator on the voltage value of a feedback signal and the voltage value of a low reference voltage level; and activating the first switch when the voltage value of the feedback signal is less than the voltage value of the low reference voltage level, the first switch being activated for a predetermined period of time.

18. The method of claim 16, further comprising comparing, by a high threshold comparator, the voltage value of a feedback signal and the voltage value of a high reference voltage level; and deactivating the second switch when the voltage value of the feedback signal is greater than the voltage value of the high reference voltage level.

19. A system, comprising:
a sampling power supply, including:
a threshold detector receiving an input voltage source for generating a threshold signal when the input voltage source substantially crosses a threshold voltage;
a first switch for receiving the input voltage source and capable of withstanding a high voltage input;
responsive to the output signal received from the threshold detector, a control circuit, coupled to the threshold detector and the first switch, for sending a control signal to activate the first switch for a predetermined period of time relative to receipt of the threshold signal; and
when the first switch is activated, a first capacitor, coupled to the first switch, for storing electrical energy from the input voltage source;
one or more sensors, coupled to the sampling power supply, for sensing one or more environmental parameters;
a microcontroller, coupled to the sampling power supply, the one or more sensors, and an electrical appliance, for controlling operations of the sampling power supply and electrical appliance as part of a smart plug.

20. The system of claim 19, wherein the electrical appliance comprises an LED lighting apparatus.

21. The system of claim 19, wherein the electrical appliance comprises a battery charger.
